(19) United States
(12) Patent Application Publication
(10) Pub. No.: US 2024/0386233 A1
(43) Pub. Date: Nov. 21, 2024

(54) TELESCOPIC INTERACTION CARD

(71) Applicant: Capital One Services, LLC, McLean, VA (US)

(72) Inventors: Bryant YEE, Silver Spring, MD (US); Tyler MAIMAN, Melville, NY (US); Cruz VARGAS, Ocean Springs, MS (US)

(73) Assignee: Capital One Services, LLC, McLean, VA (US)

(21) Appl. No.: 18/320,353

(22) Filed: May 19, 2023

(51) Int. Cl. G06K 19/077; G06K 19/04

(52) U.S. Cl. CPC G06K 19/07737; G06K 19/042

(57) ABSTRACT

Transaction cards having a telescopic design to selectively obscure transaction information and related methods are disclosed. A transaction card may include a card body having a pair of longitudinal edges perpendicular to a pair of end edges, including a top surface defined by the pair of longitudinal edges and the pair of end edges. The transaction card may also include one or more visual elements of information positioned on the top surface and an end cover portion slidably movable relative to the card body along an axis substantially parallel to the pair of longitudinal edges such that, in an obfuscation orientation, the end cover portion is positioned to cover the top surface of the card body such that the one or more visual elements of information is obfuscated when viewing the transaction card.

### TECHNICAL FIELD

Various embodiments of the present disclosure relate generally to payment or other transaction cards and, more particularly, to transaction cards having a telescopic design to selectively obscure transaction information.

### BACKGROUND

While the implementation of security measures in payment card transactions has improved security in many ways, the visible elements of transaction information on a payment card may still pose a security threat in the event they are seen by an unauthorized person. For example, even a card that includes security measures such as an EMV chip may display visible information such as the card number, expiration date, and card verification value (CVV). For some methods of transacting, these numbers are sufficient to authorize a transaction, and other methods of transaction may only require one additional piece of information, such as a card holder's zip code or phone number. While the visible elements of transaction or account information may be obscured prior to use, it is often necessary to have the card in view for some period of time, for example, during a transaction. Such visibility of information may expose an account holder to fraudsters.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, payment, transaction, or other cards having a telescopic design to selectively obscure information and related methods are disclosed. The disclosed cards may provide a card holder with additional security by limiting the amount of transaction information visible to others on the exposed surface(s) of the card.

For instance, a transaction card may include a card body having a pair of longitudinal edges perpendicular to a pair of end edges, including a top surface defined by the pair of longitudinal edges and the pair of end edges. The transaction card may also include one or more visual elements of information positioned on the top surface, an end cover portion slidably movable relative to the card body along an axis substantially parallel to the pair of longitudinal edges, and wherein, in an obfuscation orientation, the end cover portion may be positioned to cover the top surface of the card body such that the one or more visual elements of information is obfuscated when viewing the transaction card.

A method may include securing a first end cover portion to a card body, the card body having a pair of longitudinal edges perpendicular to a pair of end edges, the card body further including a top surface defined by the pair of longitudinal edges and the pair of end edges, wherein securing the first end cover portion to the card body includes positioning the first end cover portion at a first end edge of the pair of end edges; and securing a second end cover portion to the card body at a second end edge of the pair of end edges, the second end edge being opposite of the first end edge of the pair of end edges, wherein each of the first end cover portion and the second end cover portion is slidably movable relative to the card body along an axis substantially parallel to the pair of longitudinal edges. In an obfuscation orientation, at least one of the first end cover portion or the second end cover portion may be positioned to cover the top surface of the card body such that one or more elements of information is obfuscated from view.

According to the disclosure, a card may include a card body having a longitudinal dimension perpendicular to a width dimension, including a top surface; a first end cover portion slidably movable relative to the card body along an axis substantially parallel to the longitudinal dimension; and a second end cover portion, positioned at an opposite end of the card body, slidably moveable relative to the card body along the axis substantially parallel to the longitudinal dimension. In an obfuscation orientation, the first end cover portion may be positioned to abut the second end cover portion such that the top surface of the card body is obfuscated from view.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts an exemplary card, according to one or more embodiments of the present disclosure, in an open position, or viewing orientation.

FIG. 1B depicts an exemplary card, according to one or more embodiments of the present disclosure, in a closed position, or obfuscation orientation.

FIG. 1C depicts an exemplary card, according to one or more embodiments of the present disclosure, in a closed position, or obfuscation orientation.

FIG. 1D depicts an exemplary card, according to one or more embodiments of the present disclosure, in a closed position, or obfuscation orientation.

FIG. 1E is a cross-sectional view of the exemplary card taken along line IC-IC of FIG. 1A, in an open position.

FIG. 1F is a cross-sectional view of the exemplary card taken along line ID-ID of FIG. 1E.

FIG. 2A depicts an exemplary card, according to one or more embodiments of the present disclosure, with telescopic panels, in an open position.

FIG. 2B is a cut away view of the exemplary card of FIG. 2A in an open position.

FIGS. 3A and 3B depict an exemplary card, according to one or more embodiments of the present disclosure, the embodiment including finger holes for the opening and closing of the card between a viewing orientation and an obfuscation orientation.

FIG. 3C depicts the exemplary card of FIG. 3A, and further including a magnetic strip.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of +10% of a stated or understood value.

In general, the present disclosure is directed to payment, transaction, or other cards and, more particularly, to cards having a security cover to selectively obscure or reveal transaction information and related methods. Cards according to the present disclosure may provide additional security from cameras or unauthorized individuals seeking to view and use visible payment information from one or more surfaces of a credit card. During regular in-person use with a conventional card, information, such as the Card Verification Value (CVV), may not be necessary to complete the transaction, though it may still be exposed and visible to onlookers. By providing a security cover to obscure or conceal some or all of the visible transaction or identification information, cardholders can prevent information often needed for remote or online use from being seen during in-person transactions. In accordance with the present disclosure, the information provided with a payment, transaction, or other card can remain printed on the card, but some or all of the security information may require an extra step, for example, opening a security cover, to be viewed.

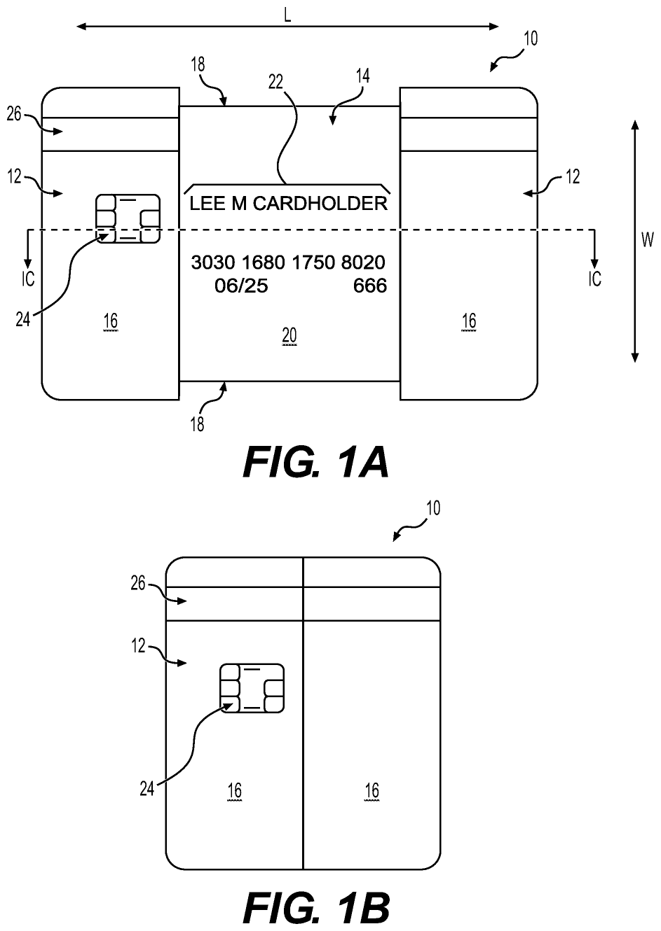

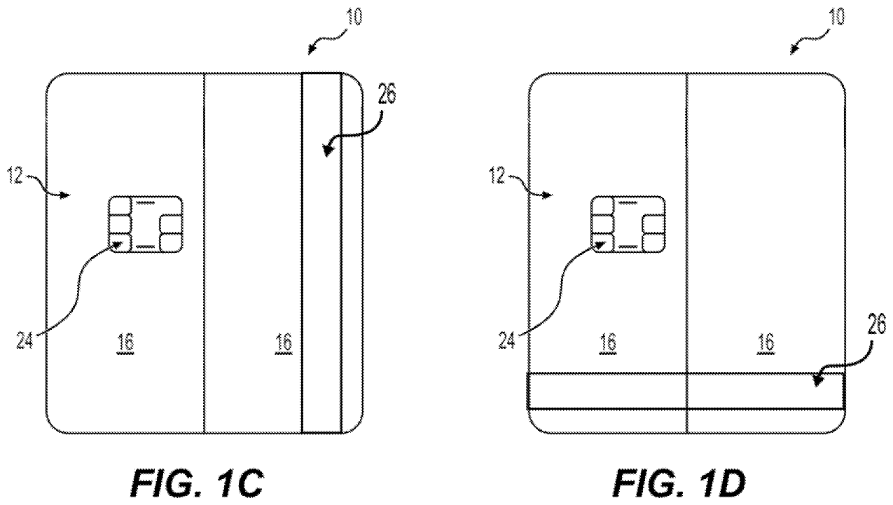

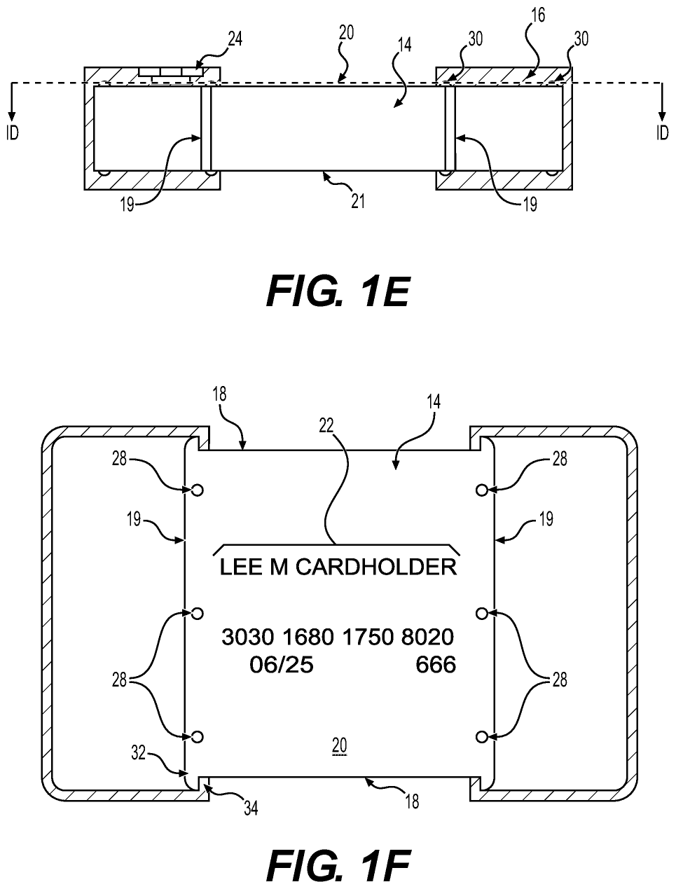

FIGS. 1A-1F depict an exemplary transaction card 10, according to one or more embodiments of the present disclosure. As illustrated, transaction card 10 may be a generally rectangular card having a longitudinal dimension L and a width dimension W and may include a cover layer 12 and a card body 14, with cover layer 12 including one or more end cover portions 16 for obscuring information. In some embodiments, the one or more end cover portions 16 are slidably moveable relative to the card body along an axis substantially parallel to longitudinal edges 18 of the card body 14. The card body 14 includes two longitudinal edges 18 and two end edges 19 (FIG. 1F) forming a generally rectangular shape with a top surface 20 and a bottom surface 21 (FIG. 1E) and defined by the four edges. On the top surface 20 of the card body, one or more visual elements of information 22 may be provided. Examples of visual elements of information 22 may include transaction information such as cardholder names, CVVs, card expiration dates, personal identification numbers (PINs), all or portions of a card identification number, other information a cardholder may have reason to protect from unauthorized third parties, or any combination thereof.

FIG. 1A depicts the exemplary transaction card 10 in an open position. In this embodiment, both of two end cover portions 16 positioned at respective end edges 19 of the card body 14 have been slidably moved to an open position to reveal the one or more visual elements of information 22 printed on the top surface 20 of the card body 14. In the exemplary embodiment, the two end cover portions 16 are shown with substantially equal dimensions in the longitudinal direction. In some embodiments, one end cover portion 16 may be substantially longer or shorter than the other end cover portion. In yet other embodiments, only one of the end cover portions 16 is slidably moveable, while the other is fixed to the card body 10. In such embodiments, the positioning of the visual elements of information 22 on the top surface 20 of the card body may be adjusted such that it is completely visible when the slidably movable end cover portion is moved into an open position. For example, the visual elements of information 22 may be printed on the top surface 20 of the card body nearer one end edge 19 of the card body than the other. In these embodiments as well, the two end cover portions 16 may be of substantially identical dimensions, or one end cover portion 16 may be longer or shorter than the other end cover portion 16. In one embodiment, the slidably movable end cover portion 16 may be longer in the longitudinal direction than the fixed end cover portion 16, and may be dimensioned such that its dimensions are generally similar to that of the card body 14.

FIG. 1B depicts the exemplary transaction card 10 in a closed position or obfuscation orientation. In this position, the end cover portions 16 abut each other and obfuscate the one or more visual elements of information 22. An EMV chip 24 and magnetic strip 26 may be provided on the cover layer 12 so that they can be usable in a closed position. As such, a cardholder may keep the transaction card 10 in the closed position and it may remain usable for most transactions. Accordingly, opening the end cover portions 16 is only required when it is necessary to reference the visual elements of information 22 printed on the top surface 20 of the card body 14. This allows the cardholder to engage in most in-person transactions that are conducted in public spaces without unintentionally exposing any visual elements of information to unauthorized third parties. The magnetic strip 26 may be provided on only one or both end cover portions 16, and may be provided in a vertical or horizontal orientation with respect to the longitudinal dimension. In some embodiments, such as that shown in FIG. 1C, the magnetic strip 26 may be applied in a vertical orientation on one end cover portion 16. In other embodiments, the magnetic strip is continuously applied across both end cover portions in a position lower than the EMV chip in the width direction of the card. In the embodiments of FIGS. 1B and 1D, the magnetic strip 26 may also be present on just one of the end cover portions 16.

FIG. 1E is a cross-sectional view of the exemplary transaction card 10 taken along line IC-IC of FIG. 1A, when the card is in an open position according to one or more embodiments of the present disclosure. In some embodiments, one or more closures may be provided to retain the end cover portions 16 in the obfuscation orientation. For example, the closures may be one or more of a magnetic closure, a clasp, a snap, and a detent mechanism. In the exemplary embodiment shown in FIG. 1E, a detent mechanism is shown that includes a series of protrusions 28 on the card body 14 and corresponding receptacles 30 on the end cover portions 16. Alternatively, the protrusions 28 may be made on the end cover portions 16 and the receptacles 30 on the card body. In yet another embodiment, both the card body 14 and the end cover portions 16 may have a combination of protrusions 28 and receptacles 30. In the exemplary embodiment shown, there are three protrusions 28 and three receptacles 30 for each detent mechanism, and the protrusions 28 and receptacles 30 are of a substantially round or circular shape. However, there may be embodiments with more or less protrusions 28 and receptacles 30, and the protrusions 28 may take on any reasonable shape, such as a cubic or rectangular bar shape, a crescent shape, a pyramid shape, or any other shape. The receptacles 30 may then be correspondingly sized and shaped to match to provide a detent mechanism.

In any of the above embodiments, in a closed position, in the obfuscation orientation, protrusions 28 are received in the receptacles 30, such that a moderate amount of force is required to slidably move the end cover portions 16 to translate the transaction card 10 into the open position. This allows for the transaction card 10 to remain in the obfuscation orientation until the cardholder intentionally initiates a sliding motion to uncover the card body 14. In the embodiments in which only one of the end portions 16 is slidably moveable, only that end portion 16 will require protrusions 28 or receptacles 30 and only the end side of the card body 14 in the longitudinal direction of the slidably moveable end portion 16 will require the corresponding protrusions 28 or receptacles 30. The protrusions 28 and/or receptacles 30 may be provided on either or both of the longitudinal edges 18 of the card body 14 and the top surface 20 of the card body, the latter being shown in the exemplary embodiment of FIGS. 1E-1F. The corresponding protrusions and/or receptacles 30 may be provided on a corresponding region of the end cover portions 16.

FIG. 1F is a cross-sectional view of the exemplary transaction card 10 taken along line ID-ID of FIG. 1E, when the card is in an open position according to one or more embodiments of the present disclosure. In some embodiments, one or more retention mechanisms may be provided to prevent the end cover portions 16 from detaching from the card body 14. In one embodiment, the retention mechanism may include catches 32 and receiving flanges 34, as seen in the exemplary embodiment shown in FIG. 1F. Catches 32 are formed on the card body 14 such that, as the end cover portions 16 are slidably moved into a fully open position, each of the catches 32 contacts a respective receiving flange 34 formed in the end cover portions 16. Once the catches 32 come into contact with the receiving flanges 34, the transaction card 10 is in a fully open position and the end cover portions 16 are prevented from being slidably removed from the card body 14.

In some embodiments, only one end cover portion 16 may be provided, the single end cover portion 16 positioned on one side of the card body 14 and having dimensions generally similar to the card body 14 so that in a closed position, the end cover portion 16 obscures substantially the entirety, or at least a majority, of the top surface 20 of the card body 16. Closures may be provided to maintain the single end cover portion 16 in the closed position substantially similar to the closures for the embodiments including two end cover portions 16 as described above, and the single end cover portion 16 is likewise slidably movable relative to the card body 14 by applying a moderate force is required to slidably move the end cover portion 16 to disengage the protrusions 28 from receptacles 30 and translate the transaction card 10 into an open position.

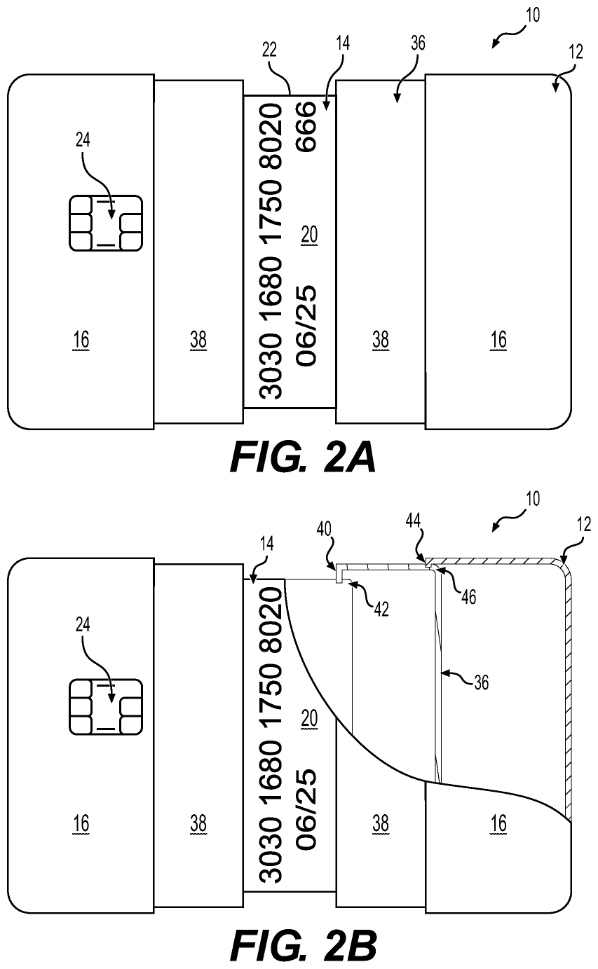

In addition to the card body 14 and the end cover portions 16, one or more embodiments of the present disclosure may optionally include a nesting telescopic layer 36 provided between the card body 14 and the cover layer 12. As shown in FIGS. 2A and 2B, the first and second telescopic panels 38 are slidably disposed between the first and second end cover portions 16 and the card body 14. Like the end cover portions 16, the telescopic panels 38 are configured to slide relative to the card body 14 along the axis substantially parallel to the longitudinal edges of the card body 14. Furthermore, the end cover portions 16 are configured to slide relative to the telescopic panels 38 along the same axis.

FIG. 2B depicts a cut away view of the transaction card of FIG. 2A. In some embodiments according to the present disclosure, the telescopic layer 36 may be comprised of two telescopic panels 38 which each include their own set of catches 40 that correspond to receiving flanges 42 on the card body in an open position. Additionally, the end cover portions 16 of the cover layer 12 may include catches 44 that correspond to receiving flanges 46 on the telescopic panels 38. In the closed position or obfuscation orientation, the cover layer 12, the telescopic portion 36, and the card body 14 are nested together with either or both of the two end cover portions 16 abutting each other and the two telescopic panels 38 abutting each other and fully enclosed within the cover layer. A magnetic strip 26 may be applied to these embodiments in a similar manner to the embodiments shown in FIGS. 1A-1F, e.g., in a vertical or horizontal configuration with respect to the longitudinal direction, and applied on one or both of end cover portions 16.

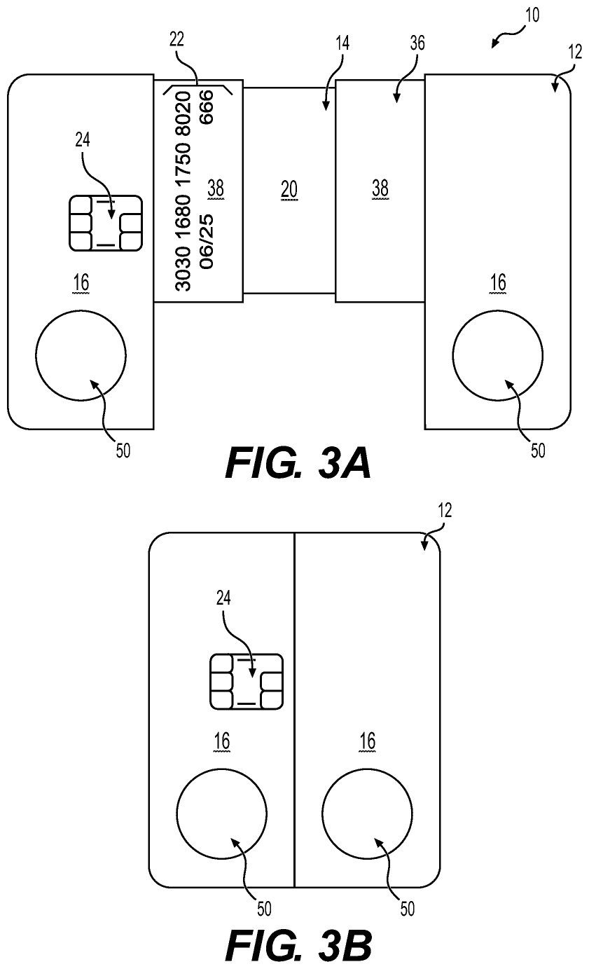

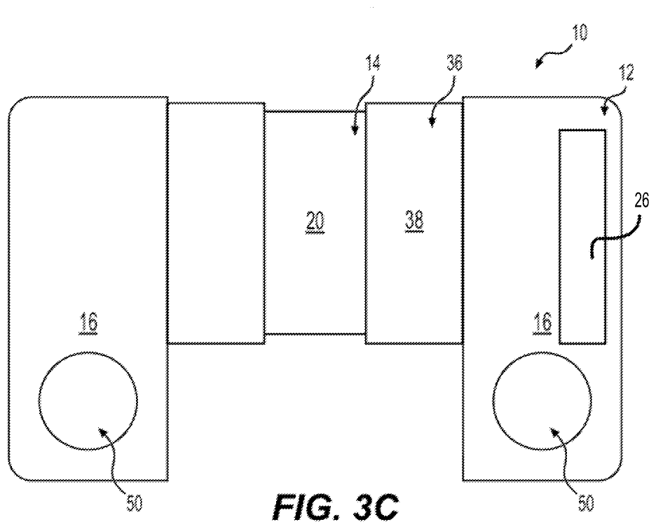

FIGS. 3A-3C depict the transaction card 10 according to a further embodiment of the present disclosure, the embodiment including openings or holes 50 for the opening and closing of the transaction card 10 between a viewing orientation and an obfuscation orientation. In some embodiments, the first and second end cover portions 16 may include first and second respective holes 50, each of the holes 50 passing through the corresponding end cover portion 16. By pushing the first and second holes 50 away from each other (e.g., via a thumb or finger of an operator), the transaction card may be transitioned from the obfuscation orientation as shown in FIG. 3A to the viewing orientation as shown in FIG. 3B. To prevent the holes 50 from interfering with the card body 14 and/or telescopic portion 36, the end cover portion 16 has a length in the width direction that is greater than that of the card body 14 and the telescopic portion 36. In one preferred embodiment, the end edges of the card body has a length that is less than about 75% of the length of the end cover portion. In other embodiments, the end edges of the card body has a length that is less than about 50% of the length of the end cover portion. A magnetic strip 26 may be applied to these embodiments in a similar manner to the embodiments shown in FIGS. 1A-1F, e.g., in a vertical or horizontal configuration with respect to the longitudinal direction, and applied on one or both of end cover portions 16. FIG. 3C shows one example of a magnetic strip 26 applied to one of the two end cover portions 16 in a vertical direction.

Card 10 may be produced by any suitable method, including a manufacturing method that includes securing a first end cover portion 16 to a card body 16. The card body 14 may have a pair of longitudinal edges 18 perpendicular to a pair of end edges 19. The card body may further include a top surface 20 and a bottom surface 21 defined by the pair of longitudinal edges 18 and the pair of end edges 19. Securing the first end cover portion 16 to the card body 14 may include positioning the first end cover portion 16 at a first end edge 19 of the pair of end edges 19, and securing a second end cover portion 16 to the card body 14 at a second end edge 19 of the pair of end edges 19. The second end edge 19 is opposite of the first end edge 19 of the pair of end edges 19. One or both of the first end cover portion 16 and the second end cover portion 16 may be slidably moveable relative to the card body along an axis substantially parallel to the pair of longitudinal edges 18. In an obfuscation orientation, at least one of the first end cover portion 16 or the second end cover portion 16 is positioned to cover the top surface 20 of the card body such that one or more elements of information 22 is obfuscated from view.

In at least one embodiment, the first end cover portion 16 and the second end cover portion 16 are secured to the card body 14 before implanting a programmed EMV chip 24, and applying the visual information 22 and magnetic strip 26 to the card. The visual information 22 may be stamped or printed in any known manner onto the card body 14, and the magnetic strip 26 may be written in any known manner onto one or both of the end cover portions 16.

In embodiments that include telescopic panels 38, the first end cover portion 16 and the second end cover portion 16 are secured to the telescopic panels 38, which are in turn secured to the card body 14 before implanting a programmed EMV chip 2624 and applying the visual information 22 and magnetic strip 26 to the card. The visual information 22 may be stamped or printed in any known manner onto the card body 14, the telescopic panels 38, and or the end cover portions 16, and the magnetic strip 26 may be written in any known manner onto one or both of the end cover portions 16.

In embodiments that include openings or holes 50, the first end cover portion 16 and the second end cover portion 16 are secured to the telescopic panels 38 and/or to the card body 14 before implanting a programmed EMV chip 24, and applying the visual information 22 and magnetic strip 26 to the card. As noted above, the visual information 22 may be stamped or printed in any known manner onto the card body 14, the telescopic panels 38, and or the end cover portions 16, and the magnetic strip 26 may be written in any known manner onto one or both of the end cover portions 16. The openings or holes 50 may either be cut out from end cover portions 16 before the end cover portions 16 are secured to the telescopic panels 38 and/or to the card body 14, or may alternatively be cut out from the end cover portions 16 after the assembly and application of the magnetic strip 26 to the card.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. In the following claims, any of the claimed embodiments can be used in any combination. For example, one or more retention mechanisms (e.g., retention edges, magnetic components, snaps, biased hinges, or other latching mechanisms) may be used in lieu of or in concert with one another.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A transaction card, comprising:
a card body having a pair of longitudinal edges perpendicular to a pair of end edges, including a top surface and a bottom surface defined by the pair of longitudinal edges and the pair of end edges;
one or more visual elements of information positioned on the top surface of the card body; and
an end cover portion slidably movable relative to the card body along an axis substantially parallel to the pair of longitudinal edges, the end cover portion including at least one of a chip and a magnetic strip;
wherein, in an obfuscation orientation, the end cover portion is positioned to cover the top surface of the card body and the bottom surface of the card body such that the one or more visual elements of information is obfuscated when viewing the transaction card.

2. The transaction card of claim 1, wherein the end cover portion is a first end cover portion and is positioned at a first end edge of the pair of end edges, the transaction card further comprising a second end cover portion positioned at a second end edge of the pair of end edges which is opposite the first end edge of the pair of end edges, the second end cover portion being slidably moveable relative to the card body along the axis substantially parallel to the pair of longitudinal edges.

3. The transaction card of claim 2, wherein the first end cover portion and the second end cover portion abut one another in the obfuscation orientation.

4. The transaction card of claim 2, wherein the first end cover portion and the second end cover portion are maintained in the obfuscation orientation by a closure.

5. The transaction card of claim 4, wherein the closure is one or more of a magnetic closure, a clasp, a snap, or a detent mechanism.

6. The transaction card of claim 2, further including a magnetic strip positioned along a surface of at least one of the first end cover portion of the second end cover portion.

7. The transaction card of claim 2, further comprising:
a pair of telescoping panels slidably disposed between the first and second end cover portions and the card body; and
wherein the telescoping panels are configured to slide relative to the card body along the axis substantially parallel to the pair of longitudinal edges;
wherein the first end cover portion and the second end cover portion are configured to slide relative to the telescoping panels along the axis substantially parallel to the pair of longitudinal edges.

8. The transaction card of claim 7, further comprising one or more visual elements of information positioned on at least one of the pair of telescopic panels, wherein:
sliding the first end cover portion and the second end cover portion relative to the telescoping panels transitions the transaction card from the obfuscation orientation to a viewing orientation in which the one or more visual elements of information are visible.

9. The transaction card of claim 8, further comprising:
a first finger hole passing through the first end cover portion;
a second end cover portion positioned at an opposite end edge of the pair of end edges, and slidably moveable relative to the card body along the axis substantially parallel to the pair of longitudinal edges; and
a second finger hole passing through the second end cover portion;
wherein, pushing the first finger hole away from the second finger hole is configured to transition the transaction card from the obfuscation orientation to a viewing orientation in which the one or more visual elements of information are visible.

10. The transaction card of claim 1, wherein the end cover portion is a first end cover portion, the transaction card further comprising:
a second end cover portion positioned at an opposite end edge of the pair of end edges, and slidably moveable relative to the card body along the axis substantially parallel to the pair of longitudinal edges;
a first finger hole passing through the first end cover portion; and
a second finger hole passing through the second end cover portion;
wherein, pushing the first finger hole away from the second finger hole is configured to transition the transaction card from the obfuscation orientation to a viewing orientation in which the one or more visual elements of information are visible.

11. A method of manufacturing a transaction card, comprising:
securing a first end cover portion to a card body, the card body having a pair of longitudinal edges perpendicular to a pair of end edges, the card body further including a top surface defined by the pair of longitudinal edges and the pair of end edges, the first end cover portion including a first finger hole passing through the end cover portion, wherein securing the first end cover portion to the card body includes positioning the first end cover portion at a first end edge of the pair of end edges; and
securing a second end cover portion to the card body at a second end edge of the pair of end edges, the second end edge being opposite of the first end edge of the pair of end edges, wherein each of the first end cover portion and the second end cover portion is slidably movable relative to the card body along an axis substantially parallel to the pair of longitudinal edges;
wherein, in an obfuscation orientation, at least one of the first end cover portion or the second end cover portion is positioned to cover the top surface of the card body such that one or more elements of information is obfuscated from view.

12. The method of claim 11, wherein, in the obfuscation orientation, both the first end cover portion and the second end cover portion are positioned to cover the top surface of the card body such that one or more elements of information is obfuscated from view, and wherein, in the obfuscation orientation, the first end cover portion and the second end cover portion abut one another.

13. The method of claim 12, wherein the first end cover portion and the second end cover portion are maintained in the obfuscation orientation by a closure.

14. The method of claim 13, wherein the closure is one or more of a magnetic closure, a clasp, a snap, or a detent mechanism.

15. The method of claim 11, further comprising securing a magnetic strip on a surface of the second end cover portion.

16. The method of claim 11, further comprising:
securing, between the first end cover portion and the card body, a first telescoping panel; and
securing, between the second end cover portion and the card body, a second telescoping panel;
wherein the first telescoping panel and the second telescoping panel are configured to slide relative to the card body along the axis substantially parallel to the pair of longitudinal edges.

17. The method of claim 11, wherein the pair of end edges have a length that is less than about 75% of a length of the first end cover portion.

18. A transaction card, comprising:
a card body having a longitudinal dimension perpendicular to a width dimension, including a top surface;
a first end cover portion slidably movable relative to the card body along an axis substantially parallel to the longitudinal dimension, the first end cover portion including a first finger hole passing through the end cover portion; and
a second end cover portion, positioned at an opposite end of the card body, slidably moveable relative to the card body along the axis substantially parallel to the longitudinal dimension; and
a pair of telescoping panels slidably disposed between the first and second end cover portions and the card body;
wherein, in an obfuscation orientation, the first end cover portion is positioned to abut the second end cover portion such that the top surface of the card body is obfuscated from view;
wherein the telescoping panels are configured to slide relative to the card body along the axis substantially parallel to the pair of longitudinal edges;
wherein the first end cover portion and the second end cover portion are configured to slide relative to the telescoping panels along the axis substantially parallel to the pair of longitudinal edges.

19. The transaction card of claim 18, wherein the first end cover portion and the second end cover portion are maintained in the obfuscation orientation by a closure.

20. The transaction card of claim 18, further comprising one or more visual elements of information positioned on the top surface.
